(19) United States
(12) Patent Application Publication
(10) Pub. No.: US 2018/0213210 A1
(43) Pub. Date: Jul. 26, 2018

(54) 3D HEAD-UP DISPLAY SYSTEM AND METHOD

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Pai Sun, Beijing (CN); Jie Yu, Beijing (CN); Yanbing Yu, Beijing (CN)

(21) Appl. No.: 15/543,970

(22) PCT Filed: Jan. 9, 2017
(86) PCT No.: PCT/CN2017/070641

§ 371 Date: Jul. 14, 2017

(30) Foreign Application Priority Data
Jun. 28, 2016 (CN) 201610490759.1

(51) Int. Cl. H04N 13/332; G02B 27/22; G02B 27/01

(52) U.S. Cl. CPC H04N 13/044; G02B 2027/0134; G02B 27/0101; G02B 27/2242

(57) ABSTRACT

A 3D head-up display system and a method for 3D head-up display are disclosed. The 3D head-up display system comprises: a signal receiving module configured to receive a signal; a signal processing module configured to receive and process the signal received by the signal receiving module to generate a left-eye signal and a right-eye signal; a left head-up display device configured to receive the left-eye signal and generate a left-eye image; a right head-up display device configured to receive the right-eye signal and generate a right-eye image; a left optical system configured to project the left-eye image generated by the left head-up display device; and a right optical system configured to project the right-eye image generated by the right head-up display device.

### CROSS-REFERENCE TO RELATED APPLICATION

This application is a Section 371 National Stage Application of International Application No. PCT/CN2017/070641, filed on 9 Jan. 2017, entitled “3D HEAD-UP DISPLAY SYSTEM AND METHOD”, which claims priority to Chinese Application No. 201610490759.1, filed on 28 Jun. 2016, incorporated herein by reference in its entirety.

### TECHNICAL FIELD

The present disclosure relates to 3D head-up display system and method.

### BACKGROUND

Head-Up Display (HUD) technique is initially applied in the field of aviation, for facilitating a pilot obtaining information during driving without lowering his head to watch instrument panel for information. In recent years, onboard HUD technologies have been greatly developed, and a principle thereof is projecting an image onto a windshield through a liquid crystal screen and an optical system.

Generally, an onboard HUD may project information regarding a vehicle (such as vehicle speed, travel distance, engine speed and the like) onto a front windshield within sight of a driver from the instrument panel, such that the driver may easily obtain information regarding the driving during driving the vehicle and thereby can safely drive the vehicle by identifying important driving information.

However, traditional HUD is usually configured to provide a two-dimensional (2D) display, which cannot vividly represent needed information.

### SUMMARY

Embodiments of the present disclosure are aimed to provide 3D head-up display system, so as to intuitively display a 3D image to an observer.

In an aspect of the present disclosure, a 3D head-up display system is provided.

According to an exemplary embodiment, the 3D head-up display system comprises: a signal receiving module configured to receive a signal; a signal processing module configured to receive and process the signal received by the signal receiving module to generate a left-eye signal and a right-eye signal; a left head-up display device configured to receive the left-eye signal and generate a left-eye image; a right head-up display device configured to receive the right-eye signal and generate a right-eye image; a left optical system configured to project the left-eye image generated by the left head-up display device; and a right optical system configured to project the right-eye image generated by the right head-up display device.

In an embodiment, the 3D head-up display system may further comprise a backlight controlling module or a LED driving device, the backlight controlling module or the LED driving device is connected to the left head-up display device and the right head-up display device respectively, the backlight controlling module is configured to provide backlight in the left head-up display device and the right head-up display device alternately, and the LED driving device is configured to drive the left head-up display device and the right head-up display device to display alternately.

In an embodiment, the 3D head-up display system may be used in a vehicle having a windshield.

In an embodiment, the left optical system may comprise a left positive lens and a left lens film, the left positive lens is disposed between the left head-up display device and the windshield, the left lens film is adhered onto the windshield at a first position corresponding to one of an observer's left eye and right eye; the right optical system may comprise a right positive lens and a right lens film, the right positive lens is disposed between the right head-up display device and the windshield, the right lens film is adhered onto the windshield at a second position corresponding to the other one of the observer's left eye and right eye.

In an embodiment, the left lens film may comprise a left triangular prism assembly and the right lens film may comprise a right triangular prism assembly.

In an embodiment, the left triangular prism assembly may comprise a left prism main portion and a plurality of left triangular prism portions formed on the left prism main portion, each of the left triangular prism portions having a refracting surface such that a light beam emitted into the left triangular prism assembly is defected leftwards; and the right triangular prism assembly may comprise a right prism main portion and a plurality of right triangular prism portions formed on the right prism main portion, each of the right triangular prism portions having a refracting surface such that a light beam emitted into the right triangular prism assembly is deflected rightwards.

In an embodiment, the left optical system may comprise a first left positive lens, a left lens and a second left positive lens, the first left positive lens, the left lens and the second left positive lens being disposed between the left head-up display device and the windshield in sequence in a direction from the left head-up display device to the windshield, such that a light beam emitted from the left head-up display device is projected onto the windshield at a first position corresponding to one of the observer's left eye and right eye; and/or the right optical system may comprise a first right positive lens, a right lens and a second right positive lens, the first right positive lens, the right lens and the second right positive lens being disposed between the right head-up display device and the windshield in sequence in a direction from the right head-up display device to the windshield, such that a light beam emitted from the right head-up display device is projected onto the windshield at a second position corresponding to the other one of the observer's left eye and right eye.

In an embodiment, the left lens may comprise a left triangular prism assembly and the right lens may comprise a right triangular prism assembly.

In an embodiment, the left triangular prism assembly may comprise a left prism main portion and a plurality of left triangular prism portions formed on the left prism main portion, each of the left triangular prism portions having a refracting surface such that a light beam emitted into the left triangular prism assembly is deflected leftwards or rightwards; and the right triangular prism assembly may comprise a right prism main portion and a plurality of right triangular prism portions formed on right prism main portion, each of the right triangular prism portions having a refracting surface such that a light beam emitted into the right triangular prism assembly is deflected rightwards or leftwards.

In an embodiment, the backlight controlling module or the LED driving device is configured to output a first driving square wave and a second driving square wave to the left head-up display device and the right head-up display device respectively, a half period difference existing between the first driving square wave and the second driving square wave.

In another aspect of the present disclosure, a method for 3D head-up display is further provided.

According to an exemplary embodiment, the method may comprises steps of: receiving an input signal; processing the received input signal to generate a left-eye image signal and a right-eye image signal; receiving the left-eye image signal to generate a left-eye image with a left head-up display device; receiving the right-eye image signal to generate a right-eye image with a right head-up display device; projecting the left-eye image generated by the left head-up display device by using a left optical system; and projecting the right-eye image generated by the right head-up display device by using a right optical system.

In an embodiment, the method may further comprise: providing backlight in the left head-up display device and the right head-up display device alternately by using a backlight controlling module or driving the left head-up display device and the right head-up display device to display alternately by using a LED driving device.

In an embodiment, the method may be implemented in a vehicle having a windshield.

In an embodiment, the step of projecting the left-eye image generated by the left head-up display device by using the left optical system comprises: projecting the left-eye image to a left lens film provided at the first position on the windshield through a left positive lens of the left optical system, such that the left-eye image is refracted to change its transmission direction and reflected by the windshield to one of an observer's left eye and right eye; and/or the step of projecting the right-eye image generated by the right head-up display device by using a right optical system comprises: projecting the right-eye image to a right lens film provided at the second position on the windshield through a right positive lens of the right optical system, such that the right-eye image is refracted to change its transmission direction and reflected by the windshield to the other one of the observer's left eye and right eye.

In an embodiment, the step of projecting the left-eye image generated by the left head-up display device by using the left optical system may comprise: transmitting the left-eye image through a first left positive lens, a left lens and a second left positive lens of the left optical system successively, and then projecting the left-eye image to the first position on the windshield where the left-eye image is reflected by the windshield to one of an observer's left eye and right eye; and/or the step of projecting the right-eye image generated by the right head-up display device by using a right optical system may comprise: transmitting the right-eye image through a first right positive lens, a right lens and a second right positive lens of the right optical system successively, and projecting the right-eye image to the second position on the windshield where the right-eye image is reflected by the windshield to the other one of the observer's left eye and right eye.

In an embodiment, the left lens film may comprise a left triangular prism assembly, the left triangular prism assembly comprises a left prism main portion and a plurality of left triangular prism portions formed on the left prism main portion, each of the left triangular prism portions having a refracting surface such that a light beam emitted into the left triangular prism assembly is deflected leftwards or rightwards; and the right lens film may comprise a right triangular prism assembly, the right triangular prism assembly comprises a right prism main portion and a plurality of right triangular prism portions formed on the right prism main portion, each of the right triangular prism portions having a refracting surface such that a light beam emitted into the right triangular prism assembly is deflected rightwards or leftwards.

In an embodiment, the left lens may comprise a left triangular prism assembly, the left triangular prism assembly comprises a left prism main portion and a plurality of left triangular prism portions formed on the left prism main portion, each of the left triangular prism portions having a refracting surface such that a light beam emitted into the left triangular prism assembly is deflected leftwards or rightwards; and the right lens may comprise a right triangular prism assembly, the right triangular prism assembly comprises a right prism main portion and a plurality of right triangular prism portions formed on the right prism main portion, each of the right triangular prism portions having a refracting surface such that a light beam emitted into the right triangular prism assembly is deflected rightwards or leftwards.

In an embodiment, the step of providing backlight in the left head-up display device and the right head-up display device alternately by using a backlight controlling module or driving the left head-up display device and the right head-up display device to display alternately by using a LED driving device may comprise: outputting a first driving square wave and a second driving square wave to the left head-up display device and the right head-up display device respectively, a half period difference existing between the first driving square wave and the second driving square wave.

In the 3D head-up display system and method according to the embodiments of the present disclosure, two head-up display devices and corresponding two sets of optical systems are used, driving information, traffic information, navigation information and the like may be projected onto the windshield to provide a naked-eye 3D display, such that the driver may vividly understand status of the vehicle and traffic information and the driving operation may be more simple and safe.

### BRIEF DESCRIPTION OF THE DRAWINGS

The above and other features and advantages of the present disclosure will become apparent by describing in detail embodiments thereof with reference to the accompanying drawings, which may help fully understand the concept of the present disclosure.

FIG. 1 is a block diagram showing a 3D head-up display system according to an embodiment of the present disclosure;

FIG. 2 is a schematic drawing showing a 3D head-up display system applied in a vehicle, according to an embodiment of the present disclosure;

FIG. 3(A) is a schematic drawing showing an optical system used in a 3D head-up display system according to an embodiment of the present disclosure;

FIGS. 3(B) and 3(C) are schematic drawings showing a left lens film and a right lens film used in the optical system of FIG. 3(A), respectively;

FIG. 4(A) is a schematic drawing showing an optical system used in a 3D head-up display system according to another embodiment of the present disclosure;

FIGS. 4(B) and 4(C) are schematic drawings showing a left lens and a right lens used in the optical system of FIG. 4(A); and

FIG. 5 is a flow chart showing a method for 3D head-up display according to an embodiment of the disclosure.

### DETAILED DESCRIPTION OF PREFERRED EMBODIMENTS

Technical solutions of the present disclosure will be described hereinafter in detail in combination with exemplary embodiments thereof with reference to the attached drawings, where the like reference numerals refer to the like elements. The present disclosure should not be construed as being limited to the embodiment set forth herein; rather, these embodiments are provided to fully convey the general inventive concept of the disclosure.

Moreover, many details are provided in the following description such that embodiments of the present disclosure are explicated and can be fully understood. Obviously, however, one or more embodiments can be implemented without these details. In other cases, well-known structures and devices are schematically illustrated so as to simplify the drawings.

Directional terms such as “front”, “rear”, “left” and “right” are used in order to facilitate the description and to indicate directions with respect to a driver who is driving normally, unless otherwise stated.

According to an aspect of a general concept of the present disclosure, there is provided a 3D head-up display system, which comprises: a signal receiving module configured to receive a signal; a signal processing module configured to receive and process the signal received by the signal receiving module to generate a left-eye image and a right-eye image; a left head-up display device configured to receive and project the left-eye image generated by the signal processing module; a right head-up display device configured to receive and project the right-eye image generated by the signal processing module; a left optical system configured to project the left-eye image projected from the left head-up display device into an observer's left eye; and a right optical system configured to project the right-eye image projected from the right head-up display device into the observer's right eye.

In the 3D head-up display system according the present disclosure, driving information, traffic information, navigation information and the like can be projected onto the front windshield to provide a three-dimensional (3D) display by using two head-up display devices and corresponding two sets of optical systems, such that the driver may vividly understand status of the vehicle and traffic information and the driving can be more simple and safe.

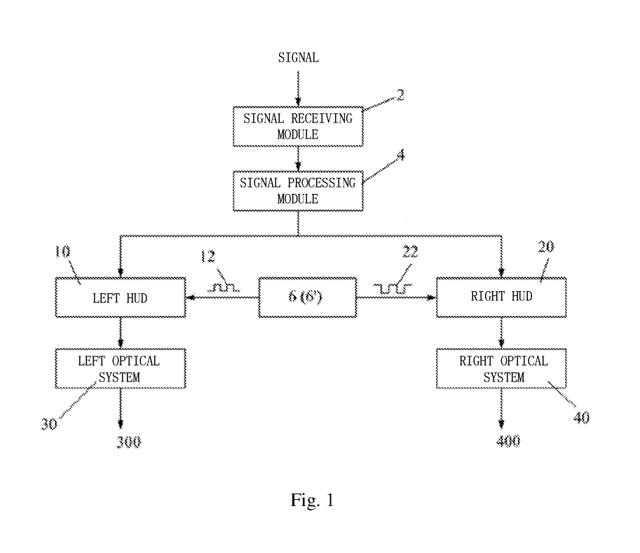

FIG. 1 is a block diagram showing a 3D head-up display system according an embodiment of the disclosure. As shown, the 3D head-up display system according to the embodiment of the present disclosure includes:

a signal receiving module 2 configured to receive a signal, which may be a signal received from a central control station or an onboard computer, or a signal received from a portable device such a mobile phone, a tablet computer or the like, and which may be a signal of any kind such as a text signal, an acoustic signal, or an image signal;

a signal processing module 4 configured to receive and process the signal received by the signal receiving module 2 to generate a left-eye signal and a right-eye signal;

a left head-up display device (HUD) 10 configured to receive the left-eye signal and generate a left-eye image;

a right head-up display device 20 configured to receive the right-eye signal and generate a right-eye image;

a left optical system 30 configured to project the left-eye image generated by the left head-up display device 10 on the windshield at, for example, a first position 300; and

a right optical system 40 configured to project the right-eye image generated by the right head-up display device 20 on the windshield at, for example, a second position 400 different from the first position 300.

The signal is transmitted among the signal receiving module 2, the signal processing module 4, the left head-up display device 10 and the right head-up display device 20, and signal transmission among these components may be realized through a wired communication or a wireless communication, such as Bluetooth, WIFI or the like.

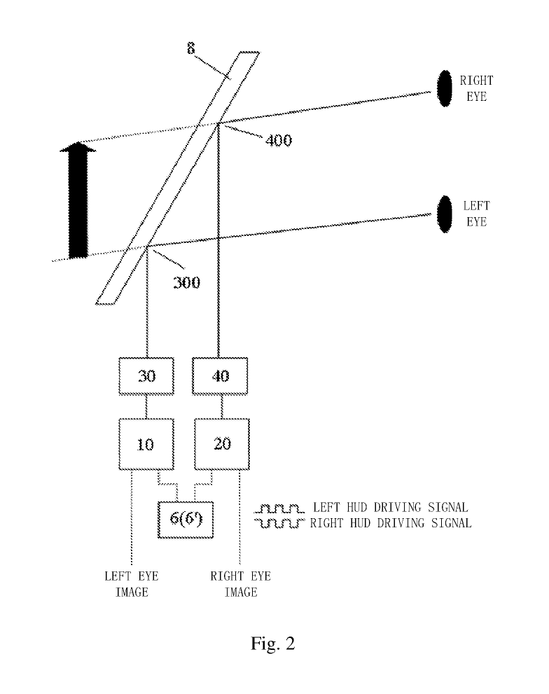

FIG. 2 is a schematic drawing showing a 3D head-up display system applied in a vehicle according to an embodiment of the present disclosure. As shown in FIG. 2, when a driver is driving and looking straight ahead, the first position 300 is aligned with the left eye of the driver and the second position 400 is aligned with the right eye of the driver. Light emitted or projected from the left head-up display device 10 passes through the left optical system 30, the windshield 8 and arrives at the driver's left eye, and light emitted or projected from the right head-up display device 20 passes through the right optical system 40, the windshield 8 and arrives at the driver's right eye, then a 3D image is formed in front of the windshield 8.

To be noted, positions and orientations of the driver's left eye, the driver's right eye, the windshield and the 3D head-up display system shown in FIG. 2 are merely exemplary. In practice, position and orientation of the 3D head-up display system may be set based on the positions and the orientations of the driver's left eye, the driver's right eye and the windshield.

Further, according to an embodiment of the present disclosure, the 3D head-up display system may also include a backlight controlling module 6, which is connected to the left head-up display device 10 and the right head-up display device 20 respectively, to provide backlight in the left head-up display device and the right head-up display device alternately. Alternatively, for a head-up display device without backlight, such as an OLED type head-up display device, the 3D head-up display system may also include a LED driving device 6′. For example, the LED driving device 6′ is connected to the left head-up display device 10 and the right head-up display device 20 respectively, to drive the left head-up display device and the right head-up display device to display alternately. With the backlight controlling module 6 or the LED driving device 6′, the left head-up display device and the right head-up display device can be controlled to display or project images alternately, in such a manner and with the use of the left optical system and the right optical system, the left-eye image and the right-eye image can be ensured to be provided into the driver's left eye and right eye respectively and a clear naked-eye 3D display effect can be generated by different images observed by the left eye and the right eye, and problems such as double image, vertigo or the like will not occur.

According to an embodiment, the backlight controlling module 6 or the LED driving device 6′ outputs a first driving square wave 12 and a second driving square wave 22 to the left head-up display device 10 and the right head-up display device 20 respectively. As shown in FIGS. 1 and 2, a half period difference exists between the first driving square wave 12 and the second driving square wave 22. More preferably, frequencies of the first driving square wave 12 and the second driving square wave 22 are at least 120 Hz, so as to ensure that the driver would not notice adverse display effect, such as flickers.

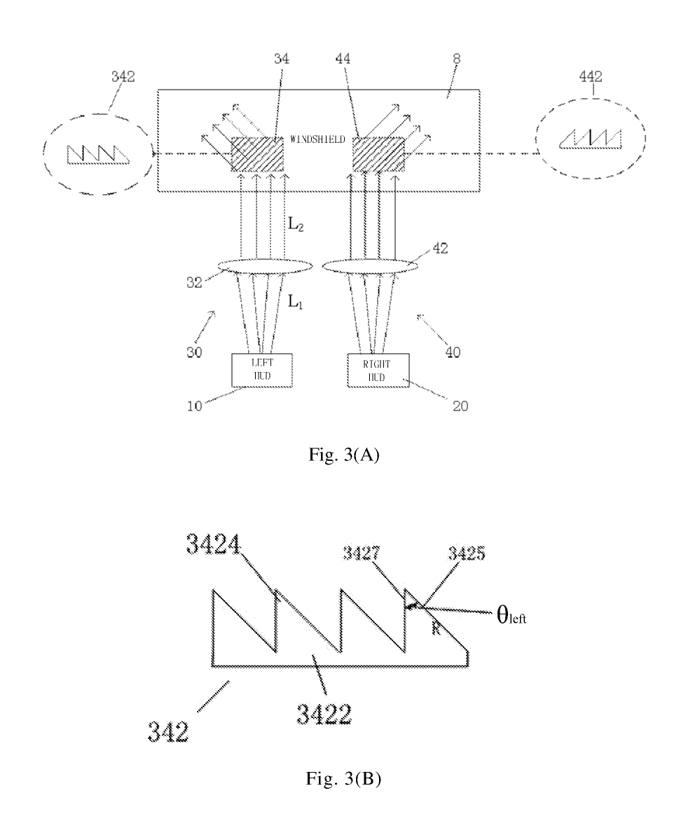

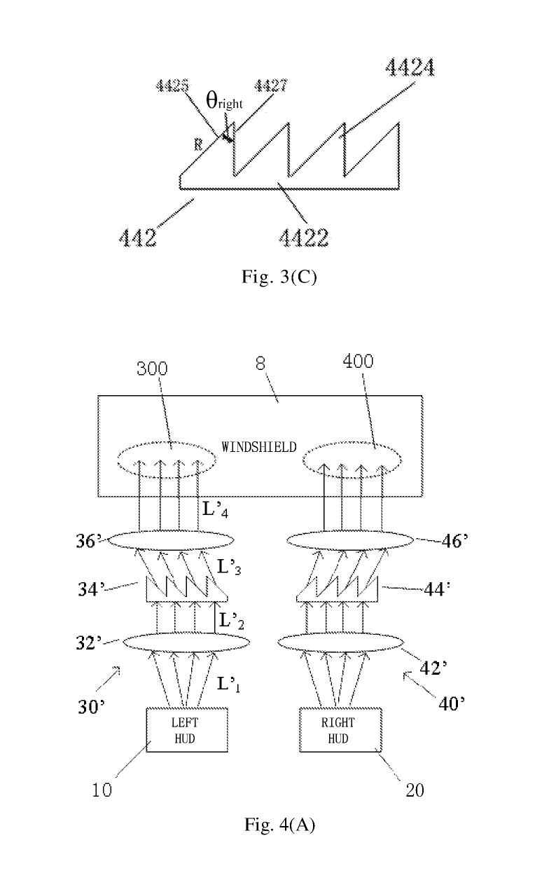

FIG. 3(A) is a schematic drawing showing an optical system used in the 3D head-up display system according to an embodiment of the present disclosure. Specifically, the left optical system 30 includes a left positive lens 32 and a left lens film 34, the left positive lens 32 is disposed between the left head-up display device 10 and the windshield 8, and the left lens film 34 is adhered onto the windshield 8 at a first position 300. Specifically, a light beam L₁ emitted or projected from the left head-up display device 10 first passes through the left positive lens 32 and is converted into a parallel light beam L₂, then the parallel light beam L₂ is transmitted to the left lens film 34 adhered at the first position 300 of the windshield 8 and is deflected leftwards, such that an aim of projecting the left-eye image into the driver's left eye can be achieved.

Further, the right optical system 40 includes a right positive lens 42 and a right lens film 44, the right positive lens 42 is disposed between the right head-up display device 20 and the windshield 8, and the right lens film 44 is adhered onto the windshield 8 at a second position 400, so as to deflect a light beam emitted from the right head-up display device 20 rightwards. A light path in the right optical system 40 is similar to the light path in the left optical system 30 and will not be described in detail herein.

With the optical systems designed as above, it can ensure that the left-eye image and the right-eye image emitted or projected respectively from the left head-up display device 10 and the right head-up display device 20 can be refracted into the driver's left eye and right eye, such that a clear naked-eye 3D display effect can be ensured, and problems such as double image, vertigo or the like will not occur.

In other embodiments that are not shown, the right optical system and/or the left optical system may also be differently configured or constructed according to practical situations. For example, the left positive lens 32 and/or the right positive lens 42 may be replaced by a set of lenses, such that an even higher magnification ratio can be realized, or the magnification ratio can be adjusted.

As shown in FIG. 3(B), according to an embodiment, the left lens film 34 includes a left triangular prism assembly 342. Further, the left triangular prism assembly 342 includes a left prism main portion 3422 and a plurality of left triangular prism portions 3424 formed on the left prism main portion 3422, each left triangular prism portion 3424 has a first left prism side face 3425 forming a refracting surface R and a second left prism side face 3427 adjacent to the first left prism side face 3425, and the first left prism side face 3425 and the second left prism side face 3427 intersect with each other and form a left prism angle θ_{left}, so as to deflect a light beam emitted into the left triangular prism assembly 342 leftwards. It can be seen from the light path shown in FIG. 3(A) that a direction in which the light beam exits from the left triangular prism assembly 342 after being deflected by the left triangular prism assembly 342 is associated with the left prism angle θ_{left}. Therefore, a left triangular prism assembly having a suitable left prism angle θ_{left} may be selected, such that the left-eye image is refracted to change its transmission direction and reflected by the windshield and then transmitted into the driver's left eye.

Further, as shown in FIG. 3(C), the right lens film 44 includes a right triangular prism assembly 442. Further, the right triangular prism assembly 442 includes a right prism main portion 4422 and a plurality of right triangular prism portions 4424 formed on the right prism main portion 4422, each right triangular prism portion 4424 has a first right prism side face 4425 forming a refracting surface R and a second right prism side face 4427 adjacent to the first right prism side face 4425, the first right prism side face 4425 and the second right prism side face 4427 intersect with each other and forms a right prism angle θ_{right}, so as to deflect a light beam emitted into the right triangular prism assembly 442 rightwards. It can be seen from the light path shown in FIG. 3(A) that a direction in which the light beam exits from the right triangular prism assembly 442 after being deflected by the right triangular prism assembly 442 is associated with the right prism angle θ_{right}. Therefore, a right triangular prism assembly having a suitable right prism angle θ_{right} may be selected, such that the right-eye image is refracted to change its transmission direction and reflected by the windshield and then transmitted into the driver's right eye.

In another embodiment that is not shown, the right lens film may also be configured such that light beam is refracted leftwards and reflected by the windshield to be transmitted into the driver's left eye, and correspondingly, the left lens film is configured such that light beam is refracted rightwards and reflected by the windshield to be transmitted into the driver's right eye.

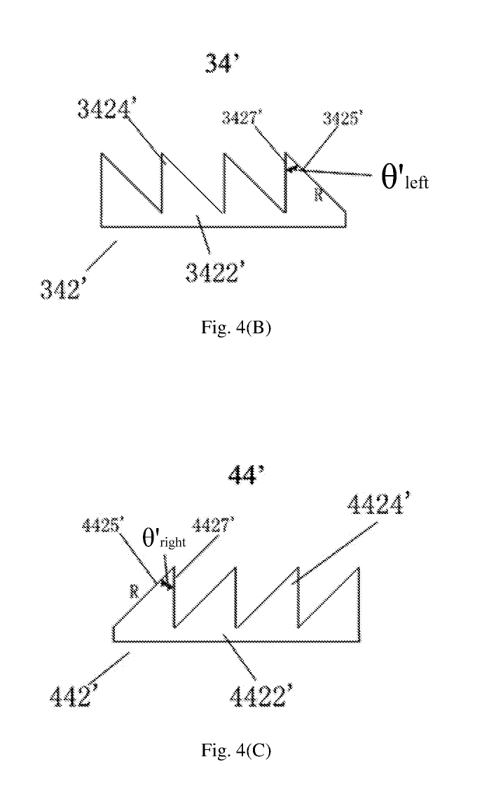

FIG. 4(A) is a schematic drawing showing an optical system used in a 3D head-up display system according to another embodiment of the present disclosure. Specifically, the left optical system 30′ includes a first left positive lens 32′, a left lens 34′ and a second left positive lens 36′. The first left positive lens 32′, the left lens 34′ and the second left positive lens 36′ are arranged between the left head-up display device 10 and the windshield 8 in sequence in a direction from the left head-up display device 10 to the windshield 8, such that a light beam emitted from the left head-up display device 10 is deflected leftwards. Specifically, a divergent light beam L′₁ emitted or projected from the left head-up display device 10 firstly passes through the first left positive lens 32′ and is converged and converted into a light beam L′₂, then the light beam L′₂ passes through the left lens 34′ and is deflected leftwards and becomes a light beam L′₃, the light beam L′₃ passes through the second left positive lens 36′ and is further converged into a parallel light beam L′₄, the parallel light beam L′₄ is projected onto the windshield 8 at the first position 300 and reflected by the windshield 8, then the light beam L′₄ is transmitted into the driver's left eye, such that an aim of projecting the left-eye image into the driver's left eye can be achieved.

Further, the right optical system 40′ includes a first right positive lens 42′, a right lens 44′ and a second right positive lens 46′. The first right positive lens 42′, right lens 44′ and the second right positive lens 46′ are arranged between the right head-up display device 20 and the windshield 8 in sequence in a direction from the right head-up display device 20 to the windshield 8, so as to deflect the light beam emitted from the right head-up display device 20 rightwards. A light path in the right optical system 40′ is similar to the light path in the left optical system 30′ and will not be described in detail herein.

To be noted, locations or position relations of optical components shown in FIG. 4(A) are just exemplary. Positions and/or orientations of each component should be set or adjusted according to position relations of the driver's left and right eyes, the windshield, the left HUD and the right HUD.

In another embodiment, for a left optical system 30′, if the first left positive lens 32′ may convert the divergent light beam L₁′ into the parallel light beam, then the second left positive lens 36′ can be omitted. The right optical system 40′ may have a similar configuration with that of left optical system 30′.

With the optical system designed in such a manner, it can also ensure that the left-eye image and the right-eye image emitted or projected respectively from the left head-up display device 10 and the right head-up display device 20 can be refracted into the driver's left eye and right eye, such that a clear naked-eye 3D display effect can be ensured, and problems such as double image, vertigo or the like will not occur.

Similarly, the left lens 34′ may have a similar configuration with that of the left lens film 34. Specifically, as shown FIG. 4(B), the left lens 34′ includes a left triangular prism assembly 342′. Further, the left triangular prism assembly 342′ includes a left prism main portion 3422′ and a plurality of left triangular prism portions 3424′ formed on the left prism main portion 3422′, each left triangular prism portion 3424′ has a first left prism side face 3425′ forming a refracting surface R and a second left prism side face 3427′ adjacent to the first left prism side face 3425′, the first left prism side face 3425′ and the second left prism side face 3427′ intersect with each other and forms a left prism angle θ′_{left}, so as to deflect a light beam emitted into the left triangular prism assembly 342′ leftwards. It can be seen from the light path shown in FIG. 4(A) that a direction in which the light beam exits from the left triangular prism assembly 342′ after being deflected by the left triangular prism assembly 342′ is associated with the left prism angle θ′_{left}. Therefore, the left prism angle θ′_{left} may be adjusted to refract the left-eye image to the first position 300 accurately.

Further, as shown in FIG. 4(C), the right lens 44′ includes a right triangular prism assembly 442′. Further, the right triangular prism assembly 442′ includes a right prism main portion 4422′ and a plurality of right triangular prism portions 4424′ formed on the right prism main portion 4422′, each right triangular prism portion 4424′ has a first right prism side face 4425′ forming a refracting surface R and a second right prism side face 4427′ adjacent to the first right prism side face 4425′, the first right prism side face 4425′ and the second right prism side face 4427′ intersect with each other and forms a right prism angle θ′_{right}, so as to deflect a light beam emitted into the right triangular prism assembly 442′ rightwards. It can be seen from the light path shown in FIG. 4(A) that a direction in which the light beam exits from the right triangular prism assembly 442′ after being deflected by the right triangular prism assembly 442′ is associated with the right prism angle θ′_{right}. Therefore, the right prism angle θ′_{right} may be adjusted to refract the right-eye image to the second position 400 accurately.

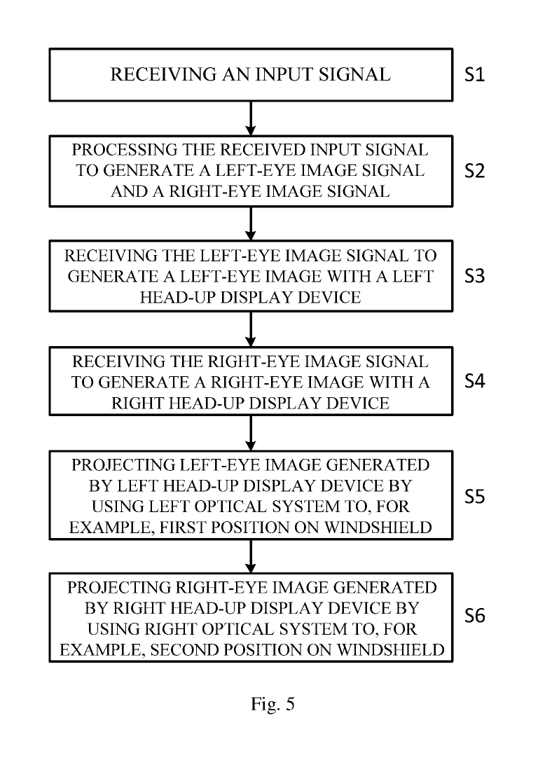

The present disclosure further provides a method for 3D head-up display. In an embodiment, as shown in FIG. 5, the method may include the following steps:

Step S1: receiving an input signal;

Step S2: processing the received input signal to generate a left-eye image signal and a right-eye image signal;

Step S3: receiving the left-eye image signal to generate a left-eye image by a left head-up display device;

Step S4: receiving the right-eye image signal to generate a right-eye image by a right head-up display device;

Step S5: projecting the left-eye image generated by the left head-up display device by using a left optical system to, for example, a first position on the windshield; and

Step S6: projecting the right-eye image generated by the right head-up display device by using a right optical system to, for example, a second position on the windshield that is different from the first position.

When a driver looks straight ahead during driving, for example, the first position is aligned with the driver's left eye and the second position is aligned with the driver's right eye.

Further, the above method may further include the following step:

Step S7: providing backlight to the left head-up display device and the right head-up display device alternately by using a backlight controlling module, or driving the left head-up display device and the right head-up display device to display alternately by using a LED driving device.

Specifically, according to an embodiment, Step S5 includes: projecting the left-eye image to a left lens film at the first position on the windshield through a left positive lens of the left optical system, such that the left-eye image is refracted to change its transmission direction and reflected by the windshield to one of the left eye and the right eye of the driver.

Specifically, according to an embodiment, Step S6 includes: projecting the right-eye image to a right lens film at the second position on the windshield through a right positive lens of the right optical system, such that the right-eye image is refracted to change its transmission direction and reflected by the windshield to the other one of the left eye and the right eye of the driver.

Specifically, according to another embodiment, Step S5 includes: transmitting the left-eye image through a first left positive lens, a left lens and a second left positive lens of the left optical system successively, and projecting the left-eye image to the first position on the windshield where the left-eye image is reflected by the windshield and transmitted into one of the left eye and the right eye of the driver.

Specifically, according to another embodiment, Step S6 includes: transmitting the right-eye image through a first right positive lens, a right lens and a second right positive lens of the right optical system successively, and projecting the right-eye image to the second position on the windshield where the right-eye image is reflected by the windshield and transmitted into the other one of the left eye and the right eye of the driver.

Specifically, according to an embodiment, Step S7 includes: outputting a first driving square wave and a second driving square wave to the left head-up display device and the right head-up display device respectively, a half period difference existing between the first driving square wave and the second driving square wave.

Although embodiments of the present disclosure are described taking a driver of a vehicle as an observer, the images or pictures may also be projected or provided into visual field of one or more other observers (such as passengers) in the vehicle. Embodiments described herein can obviously be implemented in other occasions where head-up display is needed besides vehicles. In this regard, these embodiments do not intend to limit the present disclosure, and they are disclosed only to illustrate one or more exemplary aspects of the present disclosure.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A 3D head-up display system, comprising:
a signal receiving module configured to receive a signal;
a signal processing module configured to receive and process the signal received by the signal receiving module to generate a left-eye signal and a right-eye signal;
a left head-up display device configured to receive the left-eye signal and generate a left-eye image;
a right head-up display device configured to receive the right-eye signal and generate a right-eye image;
a left optical system configured to project the left-eye image generated by the left head-up display device; and
a right optical system configured to project the right-eye image generated by the right head-up display device.

2. The 3D head-up display system according to claim 1, further comprising:
a backlight controlling module connected to the left head-up display device and the right head-up display device respectively, the backlight controlling module being configured to provide backlight in the left head-up display device and the right head-up display device alternately; or
an LED driving device connected to the left head-up display device and the right head-up display device respectively, the LED driving device being configured to drive the left head-up display device and the right head-up display device to display alternately.

3. The 3D head-up display system according to claim 1, wherein the 3D head-up display system is used in a vehicle having a windshield.

4. The 3D head-up display system according to claim 3, wherein the left optical system comprises a left positive lens and a left lens film, the left positive lens is disposed between the left head-up display device and the windshield, the left lens film is adhered onto the windshield at a first position corresponding to one of an observer's left eye and right eye; and/or
the right optical system comprises a right positive lens and a right lens film, the right positive lens is disposed between the right head-up display device and the windshield, the right lens film is adhered onto the windshield at a second position corresponding to the other one of the observer's left eye and right eye.

5. The 3D head-up display system according to claim 4, wherein the left lens film comprises a left triangular prism assembly and the right lens film comprises a right triangular prism assembly.

6. The 3D head-up display system according to claim 5, wherein the left triangular prism assembly comprises a left prism main portion and a plurality of left triangular prism portions formed on the left prism main portion, each of the left triangular prism portions having a refracting surface such that a light beam emitted into the left triangular prism assembly is defected leftwards; and
the right triangular prism assembly comprises a right prism main portion and a plurality of right triangular prism portions formed on the right prism main portion, each of the right triangular prism portions having a refracting surface such that a light beam emitted into the right triangular prism assembly is deflected rightwards.

7. The 3D head-up display system according to claim 3, wherein the left optical system comprises a first left positive lens, a left lens and a second left positive lens, the first left positive lens, the left lens and the second left positive lens being disposed between the left head-up display device and the windshield in sequence in a direction from the left head-up display device to the windshield, such that a light beam emitted from the left head-up display device is projected onto the windshield at a first position corresponding to one of the observer's left eye and right eye; and/or
the right optical system comprises a first right positive lens, a right lens and a second right positive lens, the first right positive lens, the right lens and the second right positive lens being disposed between the right head-up display device and the windshield in sequence in a direction from the right head-up display device to the windshield, such that a light beam emitted from the right head-up display device is projected onto the windshield at a second position corresponding to the other one of the observer's left eye and right eye.

8. The 3D head-up display system according to claim 7, wherein the left lens comprises a left triangular prism assembly and the right lens comprises a right triangular prism assembly.

9. The 3D head-up display system according to claim 8, wherein the left triangular prism assembly comprises a left prism main portion and a plurality of left triangular prism portions formed on the left prism main portion, each of the left triangular prism portions having a refracting surface such that a light beam emitted into the left triangular prism assembly is deflected leftwards or rightwards; and
the right triangular prism assembly comprises a right prism main portion and a plurality of right triangular prism portions formed on right prism main portion, each of the right triangular prism portions having a refracting surface such that a light beam emitted into the right triangular prism assembly is deflected rightwards or leftwards.

10. The 3D head-up display system according to claim 2, wherein the backlight controlling module or the LED driving device is configured to output a first driving square wave and a second driving square wave to the left head-up display device and the right head-up display device respectively, a half period difference existing between the first driving square wave and the second driving square wave.

11. A method for 3D head-up display, comprising steps of:
receiving an input signal;
processing the received input signal to generate a left-eye image signal and a right-eye image signal;
receiving the left-eye image signal to generate a left-eye image with a left head-up display device;
receiving the right-eye image signal to generate a right-eye image with a right head-up display device;
projecting the left-eye image generated by the left head-up display device by using a left optical system; and
projecting the right-eye image generated by the right head-up display device by using a right optical system.

12. The method according to claim 11, further comprising:
providing backlight in the left head-up display device and the right head-up display device alternately by using a backlight controlling module; or
driving the left head-up display device and the right head-up display device to display alternately by using a LED driving device.

13. The method according to claim 11, wherein the method is implemented in a vehicle having a windshield.

14. The method according to claim 13, wherein
the step of projecting the left-eye image generated by the left head-up display device by using the left optical system comprises: projecting the left-eye image to a left lens film provided at a first position on the windshield through a left positive lens of the left optical system, such that the left-eye image is refracted to change its transmission direction and reflected by the windshield to one of an observer's left eye and right eye; and/or
the step of projecting the right-eye image generated by the right head-up display device by using a right optical system comprises: projecting the right-eye image to a right lens film provided at a second position on the windshield through a right positive lens of the right optical system, such that the right-eye image is refracted to change its transmission direction and reflected by the windshield to the other one of the observer's left eye and right eye.

15. The method according to claim 13, wherein
the step of projecting the left-eye image generated by the left head-up display device by using the left optical system comprises: transmitting the left-eye image through a first left positive lens, a left lens and a second left positive lens of the left optical system successively, and then projecting the left-eye image to the first position on the windshield where the left-eye image is reflected by the windshield to one of an observer's left eye and right eye; and/or
the step of projecting the right-eye image generated by the right head-up display device by using a right optical system comprises: transmitting the right-eye image through a first right positive lens, a right lens and a second right positive lens of the right optical system successively, and projecting the right-eye image to the second position on the windshield where the right-eye image is reflected by the windshield to the other one of the observer's left eye and right eye.

16. The method according to claim 14, wherein
the left lens film comprises a left triangular prism assembly, the left triangular prism assembly comprises a left prism main portion and a plurality of left triangular prism portions formed on the left prism main portion, each of the left triangular prism portions having a refracting surface such that a light beam emitted into the left triangular prism assembly is deflected leftwards or rightwards; and
the right lens film comprises a right triangular prism assembly, the right triangular prism assembly comprises a right prism main portion and a plurality of right triangular prism portions formed on the right prism main portion, each of the right triangular prism portions having a refracting surface such that a light beam emitted into the right triangular prism assembly is deflected rightwards or leftwards.

17. The method according to claim 15, wherein
the left lens comprises a left triangular prism assembly, the left triangular prism assembly comprises a left prism main portion and a plurality of left triangular prism portions formed on the left prism main portion, each of the left triangular prism portions having a refracting surface such that a light beam emitted into the left triangular prism assembly is deflected leftwards or rightwards; and
the right lens comprises a right triangular prism assembly, the right triangular prism assembly comprises a right prism main portion and a plurality of right triangular prism portions formed on the right prism main portion, each of the right triangular prism portions having a refracting surface such that a light beam emitted into the right triangular prism assembly is deflected rightwards or leftwards.

18. The method according to claim 12, wherein the step of providing backlight in the left head-up display device and the right head-up display device alternately by using a backlight controlling module or driving the left head-up display device and the right head-up display device to display alternately by using a LED driving device comprises: outputting a first driving square wave and a second driving square wave to the left head-up display device and the right head-up display device respectively, a half period difference existing between the first driving square wave and the second driving square wave.
